(19) United States
(12) Patent Application Publication
(10) Pub. No.: US 2018/0249832 A1
(43) Pub. Date: Sep. 6, 2018

(54) SELF-FIXING TABLE AND CHAIR SYSTEM

(71) Applicants: Zachary David Wolfe, Houston, TX (US); Iris Diaz Wolfe, Houston, TX (US)

(72) Inventors: Zachary David Wolfe, Houston, TX (US); Iris Diaz Wolfe, Houston, TX (US)

(21) Appl. No.: 15/598,632

(22) Filed: May 18, 2017

Related U.S. Application Data
(60) Provisional application No. 62/466,139, filed on Mar. 2, 2017.

(51) Int. Cl. A47B 83/02; F16B 1/00

(52) U.S. Cl. CPC A47B 83/02; F16B 2001/0035; F16B 1/00

(57) ABSTRACT

A self-fixing table and chair system is provided that embodies a method of strategically placing magnets and in the chair components and table component, respectively, of a chair and table set. Each chair magnet and each table magnet and may be magnetically attracted to each other for suspending the chair components above a supporting surface by removably securing them to the table component.

### CROSS-REFERENCE TO RELATED APPLICATION

This application claims the benefit of priority of U.S. provisional application No. 62/466,139, filed 2 Mar. 2017, the contents of which are herein incorporated by reference.

### BACKGROUND OF THE INVENTION

The present invention relates to table and chair sets and, more particularly, to a self-fixing table and chair system.

Dining areas need to be clean and organized. When accessing underneath a table its chairs need to be removed or placed on top of the table. This is time consuming and can create hazards if the chair falls from the tabletop. Lifting and setting the chairs on the upper surface of the tabletop where people eat can be unsanitary as debris on the chairs can fall on this eating surface.

As can be seen, there is a need for a self-fixing table and chair system embodying table and chair components with embedded magnets, whereby the chair components can be attached to the table component by simply lifting the chair component to the underside or lower surface of the tabletop, removably securing the suspended chair component thereto so as to increase access to supporting surface underneath the table components, and effectively removing the dangers associated with this process.

### SUMMARY OF THE INVENTION

In one aspect of the present invention, self-fixing table and chair system includes at least one chair component, each chair component providing a seat portion adapted to accommodate a human being seated thereon; a chair magnet embedded within each seat portion; a table component providing a tabletop at least coextensive with a summation of each seat portion of the at least one chair component; the tabletop having a lower surface and an opposing upper surface; and at least one lower table magnet provided along said lower surface for each of the at least one chair component.

In another aspect of the present invention, the self-fixing table and chair system, includes at least one chair component, each chair component providing a seat portion adapted to accommodate a human being seated thereon; a chair magnet embedded within each seat portion; a table component providing a tabletop at least coextensive with a summation of each seat portion of the at least one chair component; the tabletop having a lower surface and an opposing upper surface; at least one lower table magnet provided embedded in said lower surface for each of the at least one chair component; and at least one upper table magnet provided embedded in said upper surface for each of the at least one chair component, wherein each upper table magnet is vertically aligned with a lower table magnet, wherein each chair magnet and each upper table magnet provides an operative surface flush or nearly flush with a respective seat portion and said upper surface, respectively.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a side view of an exemplary embodiment of the present invention, demonstrating a chair component in a lower engaged condition;

FIG. 3 is a section view of an exemplary embodiment of the present invention, taken along line 3-3 of FIG. 1, illustrating the chair component in the lower engaged condition;

FIG. 4 is a section view of an exemplary embodiment of the present invention, taken along line 4-4 of FIG. 1, illustrating the chair component in the lower engaged condition;

FIG. 5 is a section view of an exemplary embodiment of the present invention, demonstrating a chair component in a disengaged condition; and

FIG. 6 is a perspective view of an exemplary embodiment of the present invention, demonstrating a chair component in an upper engaged condition.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a self-fixing table and chair system that embodies a method of strategically placing magnets and in the chair components and table component, respectively, of a chair and table set. Each chair magnet and each table magnet and may be magnetically attracted to each other for suspending the chair components above a supporting surface by removably securing them to the table component.

It should be understood by those skilled in the art that the use of directional terms such as upper, lower, upward, downwardly, top and the like are used in relation to the illustrative embodiments as they are depicted in the figures, the upward direction (or upper) being toward the top of the corresponding figures and a downward direction being toward the bottom of the corresponding figure.

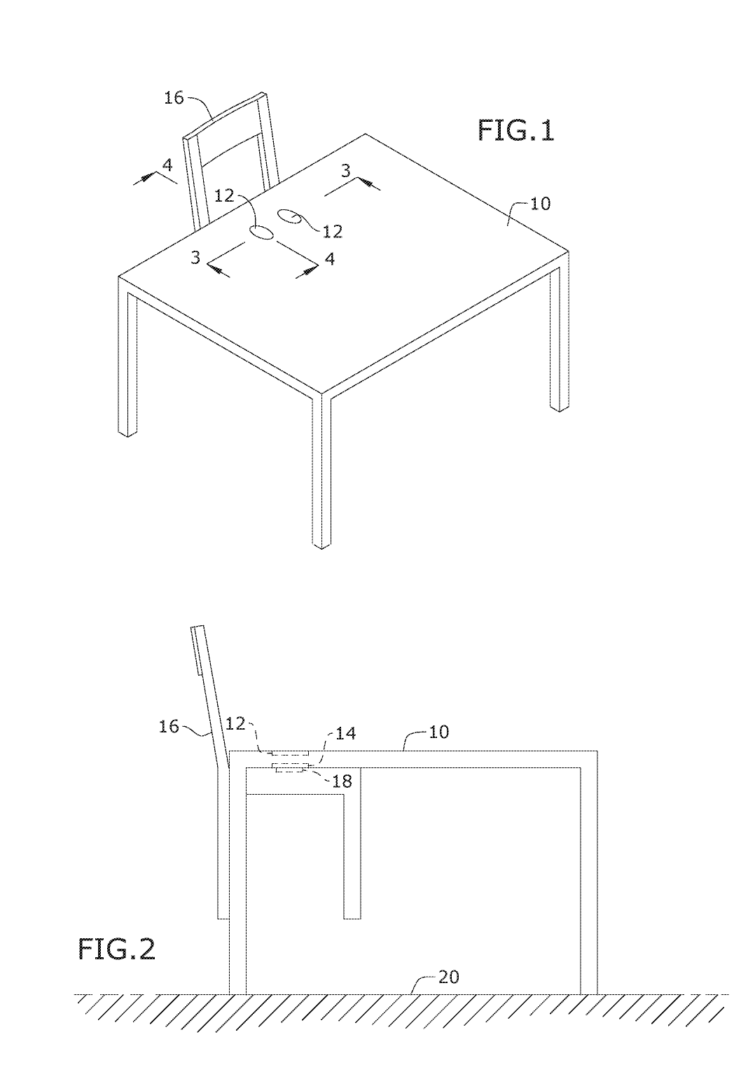

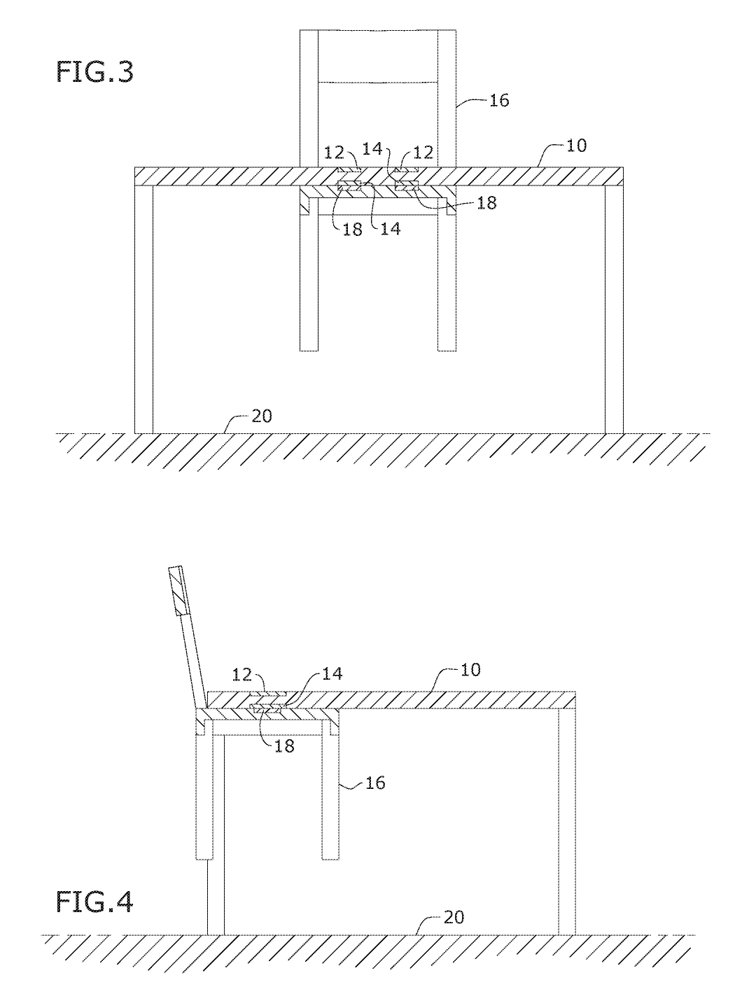

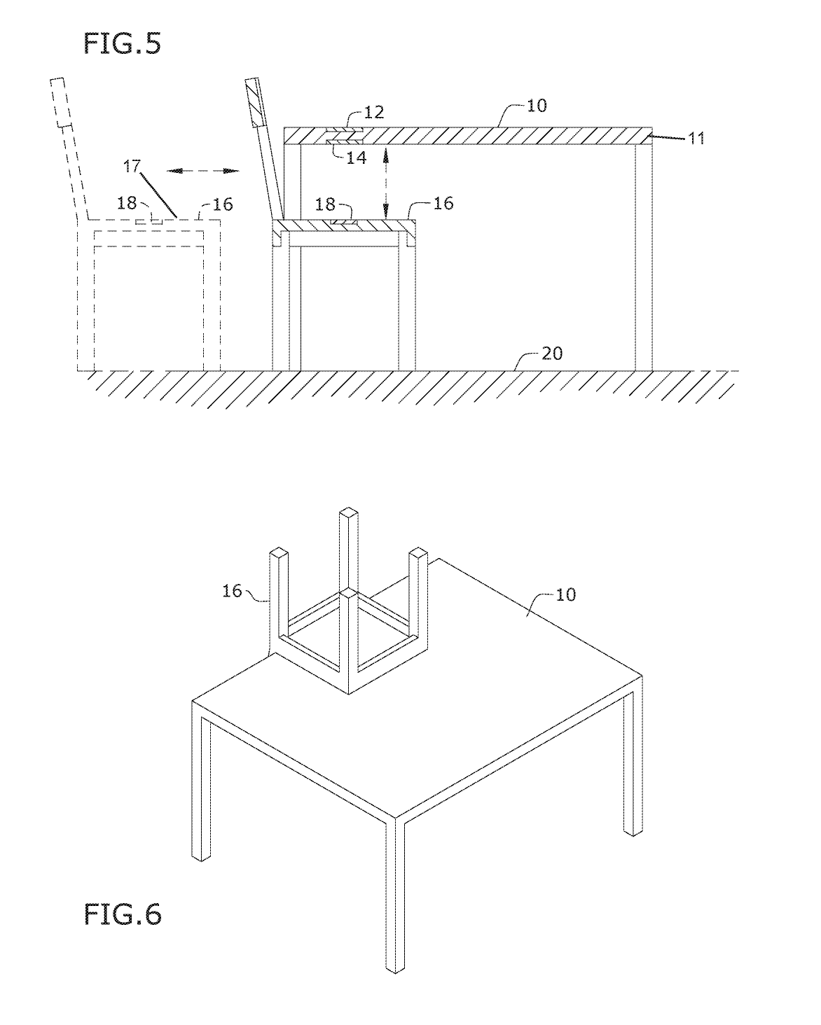

Referring to FIGS. 1 through 6, the present invention may include a self-fixing table and chair system that embodies a method of strategically placing magnets 18 and 12/14 in the chair components 16 and table component 10, respectively, of a chair and table set. Each chair magnet 18 and each table magnet 12 and 14 may be magnetically attracted to each other for suspending the chair components 16 above a supporting surface 20 by magnetically removably securing them to the table component.

The magnets 18 and 12/14 may be embedded in their respective components. In certain embodiments, the chair magnets 18 may be disposed along a surface of a seat portion 17 of each chair component 16. In certain embodiments, the table magnets 12/14 may be disposed along an upper and lower surface, respectively, of a tabletop 11 of the table component 10. In certain embodiments, the table magnets 12/14 may be vertically aligned; defining a set of upper and lower table magnets 12 and 14, so to speak. There may be two such sets per chair component 16, as illustrated in FIG. 1. Each set, or pair of sets, may be spaced apart along the edge of the table component 10 to accommodate all the chair components 16. With that said, in certain embodiments, the upper and lower table magnets 12 and 14 may not be vertically aligned.

The table magnets 12 and 14 may be strategically positioned along the tabletop 11 so that each chair component 16 may be securely attached to either the lower or upper surface thereof. FIGS. 2-4 illustrate a lower engaged condition, wherein the seat portion 17 of the chair component 16 magnetically engages the lower table magnet 14 so as to removably secure to the lower surface of the tabletop 11. FIG. 6 illustrates an upper engaged condition, wherein the upside-down seat portion 17 of the chair component 16 magnetically engages the upper table magnet 12 so as to removably secure to the upper surface of the tabletop 11. In the engaged conditions, the chair components are securely elevated above the supporting surface 20.

The chair magnets 18 may be placed so that the weight distribution of the chair components 16 minimizes the use of magnets. Furthermore, placing the magnets closer or further away from the mid-point of gravitational center will affect the ability of the magnets to overcome the force of gravity. The magnets may be embedded so that an operative surface thereof is flush or nearly flush with a surface of its associated component; for example, in the chair component 16, the operative surface of the chair magnet 18 may be flush or nearly flush with the surface of the seat portion 17. Accordingly, the embedded magnets may be sealed in place seamlessly. In certain embodiments, laminates or paint may be applied to dining fixtures to conceal the magnets. Table and chairs from virtually any style and material may be used. Depending on weight of chair will determine size, strength, and configuration of magnets.

A method of using the present invention may include the following. The self-fixing table and chair system disclosed above may be provided. By lifting the chair component 16 so that the surface of the seat portion 17 magnetically engages the upper or lower surface of the tabletop 11, the chair and table components become affixed to one another. A user simply needs to approach the table and chair system and raise the seat portion 17 of the chair component 16 to meet the upper or lower surface of the tabletop 11 providing the cooperating table magnets 12 or 14. The attraction of the magnets may cause the chair component 16 to be effectively suspended from the supporting surface in either the upper or lower engaged condition, before being removed back to the disengaged condition.

It should be understood, of course, that the foregoing relates to exemplary embodiments of the invention and that modifications may be made without departing from the spirit and scope of the invention as set forth in the following claims.

What is claimed is:

1. A self-fixing table and chair system, comprising:
at least one chair component, each chair component providing a seat portion adapted to accommodate a human being seated thereon;
a chair magnet embedded within each seat portion;
a table component providing a tabletop at least coextensive with a summation of each seat portion of the at least one chair component;
the tabletop having a lower surface and an opposing upper surface; and
at least one lower table magnet provided along said lower surface for each of the at least one chair component.

2. The self-fixing table and chair system of claim 1, further comprising at least one upper table magnet provided along said upper surface for each of the at least one chair component.

3. The self-fixing table and chair system of claim 1, wherein each lower table magnet is embedded within said lower surface.

4. The self-fixing table and chair system of claim 2, wherein each upper table magnet is embedded within said upper surface.

5. The self-fixing table and chair system of claim 2, wherein each upper table magnet is vertically aligned with a lower table magnet.

6. The self-fixing table and chair system of claim 2, wherein each chair magnet and each upper table magnet provides an operative surface flush or nearly flush with a respective seat portion and said upper surface, respectively.

7. The self-fixing table and chair system of claim 6, wherein laminates or paint may be applied thereto separates each operative service and respective seat portion or said upper surface.

8. A self-fixing table and chair system, comprising:
at least one chair component, each chair component providing a seat portion adapted to accommodate a human being seated thereon;
a chair magnet embedded within each seat portion;
a table component providing a tabletop at least coextensive with a summation of each seat portion of the at least one chair component;
the tabletop having a lower surface and an opposing upper surface;
at least one lower table magnet provided embedded in said lower surface for each of the at least one chair component; and
at least one upper table magnet provided embedded in said upper surface for each of the at least one chair component, wherein each upper table magnet is vertically aligned with a lower table magnet,
wherein each chair magnet and each upper table magnet provides an operative surface flush or nearly flush with a respective seat portion and said upper surface, respectively.

9. The self-fixing table and chair system of claim 8, wherein laminates or paint may be applied thereto separates each operative service and respective seat portion or said upper surface.
